(19) United States
(12) Patent Application Publication
(10) Pub. No.: US 2023/0388021 A1
(43) Pub. Date: Nov. 30, 2023

(54) OPTICAL MODULE AND OPTICAL TRANSMISSION APPARATUS

(71) Applicant: Fujitsu Optical Components Limited, Kawasaki-shi (JP)

(72) Inventors: Yasushi TAKAMIYA, Kawasaki (JP); Kazuya SASAKI, Yokohama (JP); Tsuyoshi GAMO, Machida (JP); Takatoshi YAGISAWA, Kawasaki (JP)

(73) Assignee: Fujitsu Optical Components Limited, Kawasaki-shi (JP)

(21) Appl. No.: 18/130,015

(22) Filed: Apr. 3, 2023

(30) Foreign Application Priority Data
May 26, 2022 (JP) 2022-085732

(51) Int. Cl. H04B 10/50

(52) U.S. Cl. CPC H04B 10/501

(57) ABSTRACT

An optical module includes a case that contains a built-in optical component related to optical communication, a built-in electronic component, and a built-in temperature sensor that detects temperature of at least one of the optical component and the electronic component. Furthermore, the optical module includes a flow channel that is formed on at least one of surfaces of the case, that extends in a longitudinal direction of the case, and through which air flows.

### CROSS-REFERENCE TO RELATED APPLICATION

This application is based upon and claims the benefit of priority of the prior Japanese Patent Application No. 2022-085732, filed on May 26, 2022, the entire contents of which are incorporated herein by reference.

### FIELD

The embodiments discussed herein are related to an optical module and an optical transmission apparatus.

### BACKGROUND

In recent years, there is a demand for compatible optical modules while implementing, for example, high density, versatility, cost reduction, and maintainability. Accordingly, an industry standard (a Multi-Source Agreement (MSA)) has been set, and there is a demand for optical modules that conform to the MSA.

For example, optical modules used for 400 GHz specified in the MSA include C Form-factor Pluggable (CFP2) of a conventional platform, Quad Small Form-factor Pluggable Double-Density (QSFP-DD), and Octal Small Form-factor Pluggable (OSFP), and the like.

In an optical module, heat radiation of, for example, an optical component, such as a laser diode (LD), that is weak against heat and that is exposed to a digital signal processor (DSP) having a large heating value is a problem in accordance with an increase in electrical power consumption of built-in parts. Furthermore, in an optical module, a decrease in the size of a substrate is facilitated and a mounting area is reduced, so that it is difficult to move the optical component to a place that is not affected by heat.
Patent Document 1: Japanese Laid-open Patent Publication No. 2004-111633
Patent Document 2: U.S. patent Ser. No. 10/147,666
Patent Document 3: Japanese Laid-open Patent Publication No. 06-29675
Patent Document 4: Japanese Laid-open Patent Publication No. 09-83046
Patent Document 5: U.S. Patent Application Publication No. 2014/0321061

However, in an optical module, an amount of heat incited to an optical component that is weak against heat from an electronic component, such as a DSP, that has a large heating value is large, a development of heat radiation is a problem in order to maintain the optical component at a guaranteed operating temperature. In an optical module defined in the MSA, in general, heat radiation is emitted by way of a heat sink that is disposed on a top surface, and it is thus difficult to locally cool an optical component and an electronic component. Accordingly, in the optical module, there is a need to locally cool the built-in optical component and the built-in electronic component.

### SUMMARY

According to an aspect of an embodiment, an optical module includes a case and a flow channel. The case contains a built-in optical component related to optical communication, a built-in electronic component, and a built-in temperature sensor that detects temperature of at least one of the optical component and the electronic component. The flow channel is formed on at least one of surfaces of the case, extends in a longitudinal direction of the case. Air flows through the flow channel.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an exploded perspective view illustrating an example of an optical module according to a first embodiment;

FIG. 2 is a perspective view illustrating an example of the optical module according to the first embodiment;

FIG. 3 is a perspective view illustrating an example of an external case;

FIG. 4 is a schematic side view illustrating an example of a flow of air in the optical module according to the first embodiment;

FIG. 5 is am exploded perspective view illustrating an example of an optical module according to a second embodiment;

FIG. 6 is a perspective view illustrating an example of the optical module according to the second embodiment;

FIG. 7 is a schematic side view illustrating an example of a flow of air in the optical module according to the second embodiment;

FIG. 8 is an exploded perspective view illustrating an example of an optical module according to a third embodiment;

FIG. 9 is a perspective view illustrating an example of an upper case;

FIG. 10 is a perspective view illustrating an example of the optical module according to the third embodiment;

FIG. 11 is a schematic side view illustrating an example of a flow of air in the optical module according to the third embodiment;

FIG. 12 is an exploded perspective view illustrating an example of an optical module according to a fourth embodiment;

FIG. 13 is a perspective view illustrating an example of an upper case;

FIG. 14 is a perspective view illustrating an example of the optical module according to the fourth embodiment;

FIG. 15 is a perspective view illustrating an example of the optical module according to the fourth embodiment;

FIG. 16 is a schematic side view illustrating an example of a flow of air in the optical module according to the fourth embodiment;

FIG. 17 is a schematic cross-sectional diagram illustrating an example of an optical transmission apparatus according to a fifth embodiment;

FIG. 18 is a block diagram illustrating an example of the optical transmission apparatus according to the fifth embodiment;

FIG. 19 is a perspective view illustrating an example of an optical transmission apparatus according to a sixth embodiment;

FIG. 20A is a schematic cross-sectional diagram illustrating an example of an optical transmission apparatus according to a sixth embodiment;

FIG. 20B is a schematic cross-sectional diagram illustrating an example of the optical transmission apparatus according to the sixth embodiment;

FIG. 21 is a block diagram illustrating an example of the optical transmission apparatus according to the sixth embodiment;

FIG. 22 is a schematic perspective view illustrating an example of a front face side of an optical transmission apparatus according to a seventh embodiment;

FIG. 23 is a schematic perspective view illustrating an example of a back face side of the optical transmission apparatus according to the seventh embodiment;

FIG. 24 is a block diagram illustrating an example of a configuration of the optical transmission apparatus according to the seventh embodiment;

FIG. 25 is a rear view illustrating an example of the optical transmission apparatus according to the seventh embodiment;

FIG. 26 is a schematic perspective view illustrating an example of a back face side of an optical transmission apparatus according to an eighth embodiment;

FIG. 27 is a schematic side view illustrating an example of the optical transmission apparatus according to the eighth embodiment; and

FIG. 28 is a block diagram illustrating an example of a configuration of the optical transmission apparatus according to the eighth embodiment.

### DESCRIPTION OF EMBODIMENTS

Preferred embodiments of the present invention will be explained with reference to accompanying drawings. Furthermore, the present invention is not limited to the embodiments. In addition, the embodiments described below may also be used in any appropriate combination as long as the embodiments do not conflict with each other.

### (a) First Embodiment

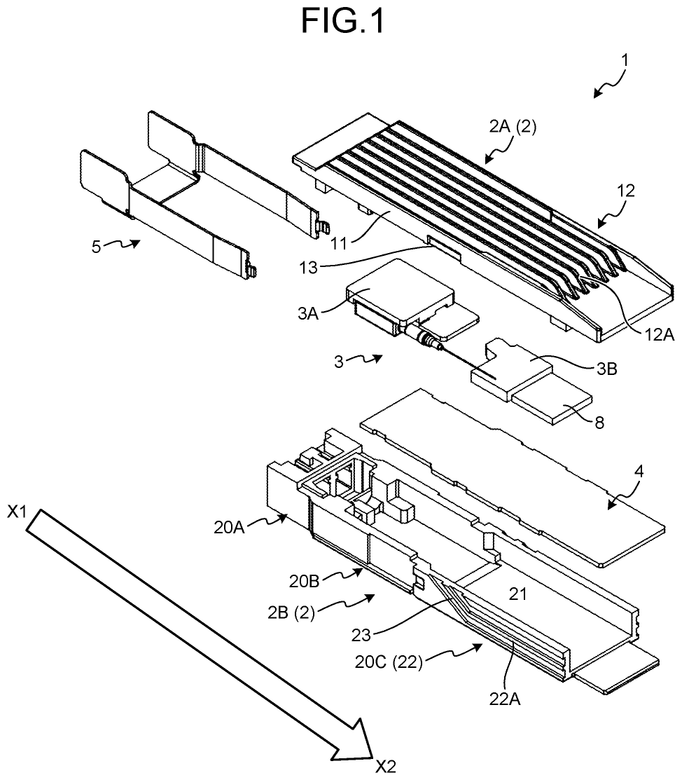

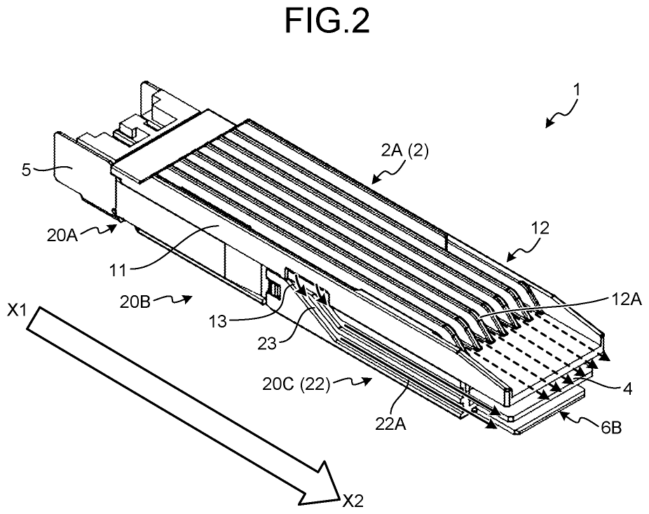

FIG. 1 is an exploded perspective view illustrating an example of an optical module 1 according to a first embodiment, and FIG. 2 is a perspective view illustrating an example of the optical module 1 according to the first embodiment. The optical module 1 illustrated in FIG. 1 includes a case 2, a substrate 4 on which a plurality of optical components 3 are mounted, and a slide sheet metal 5. The case 2 is a housing that has the built-in substrate 4 on which the plurality of optical components 3 related to optical communication are mounted. The case 2 includes an upper case 2A and a bottom case 2B. The upper case 2A is a case member disposed at an upper part of the case 2. The bottom case 2B is a case member disposed at a lower part of the case 2. The bottom case 2B includes an accommodating section 21 that accommodates therein the substrate 4 on which the optical components 3 and an electronic component 8 are mounted. In addition, a side surface section of the bottom case 2B includes a first side surface section 20A that corresponds to a front portion of the optical module 1, a third side surface section 20C that corresponds to a rear portion of the optical module 1, and a second side surface section 20B that is disposed between the first side surface section 20A and the third side surface section 20C. The case 2 includes a flow channel that is formed on at least one surface of the case 2, that extends in the longitudinal direction of the case 2, and through which air flows.

In the upper case 2A, side walls 11 that are disposed on both sides of an upper surface of the case 2, and a first heat sink 12 that is disposed between the side walls 11 located on the upper surface of the case 2 and that radiates heat from the upper surface of the case 2 are formed. The first heat sink 12 includes a plurality of first fins 12A through which air flows from a front X1 toward a rear X2 of the optical module 1, and accordingly radiates heat from the upper surface of the optical module 1 as a result of the air flowing from the front X1 toward the rear X2 by way of the first fins 12A. In addition, if the optical module 1 is mounted on an optical transmission apparatus that is not illustrated, the air flows from the front X1 toward the rear X2 of the optical module 1 as a result of driving a fan included in the optical transmission apparatus.

The first side surface section 20A included in the bottom case 2B is a region in which the slide sheet metal 5 is installed. A second heat sink 22 that radiates heat from the rear side surfaces of the optical module 1 is formed in the third side surface section 20C included in the bottom case 2B. The second heat sink 22 includes a plurality of second fins 22A through which air flows from the front X1 toward the rear X2 of the optical module 1, and accordingly radiates heat from the rear side surfaces of the optical module 1 through which the air flows from the front X1 toward the rear X2 by way of the second fins 22A.

On the side walls 11 of the upper case 2A, a duct 13 that is a ventilation hole for drawing the air flowing from the first fins 12A that are included in the first heat sink 12 into the second fins 22A that are included in the second heat sink 22. The duct 13 passing through the front and back sides of the side walls 11 at the center of the side walls 11 accordingly draws the air flowing from the first fins 12A into the second fins 22A. On the second side surface section 20B included in the bottom case 2B, a side surface flow channel 23 is formed such that the air flowing through the duct 13 formed on the side walls 11 of the upper case 2A flows through the second fins 22A when the bottom case 2B is installed together with the upper case 2A. As for the flow channels of the case 2, the duct 13 that is provided on the side surfaces of the first heat sink 12 that is disposed on the top surface of the case 2, and the second fins 22A and the side surface flow channel 23 that are ventilation paths formed on the side surfaces of the case 2 are included. The flow channel allows the air inside the first heat sink 12 to flow from the duct 13 to the second fins 22A and the side surface flow channel 23.

The optical component 3 installed inside the case 2 includes, for example, Integrable Tunable Laser Assembly (ITLA) 3A and Coherent Optical Sub-Assembly (COSA) 3B. In addition, the electronic component 8 installed in the case 2 includes, for example, an electronic circuit, such as a digital signal processor (DSP). The ITLA 3A is an optical component that emits laser light. The COSA 3B is an optical component related to coherent optical communication. The DSP is an electronic component that performs signal processing on data related to coherent optical communication. The case 2 stores therein a built-in temperature sensor that detects temperature of at least one of the optical component 3 and the electronic component 8. In the case 2, the electronic component 8 and the optical component 3 are disposed in the vicinity of the flow channel.

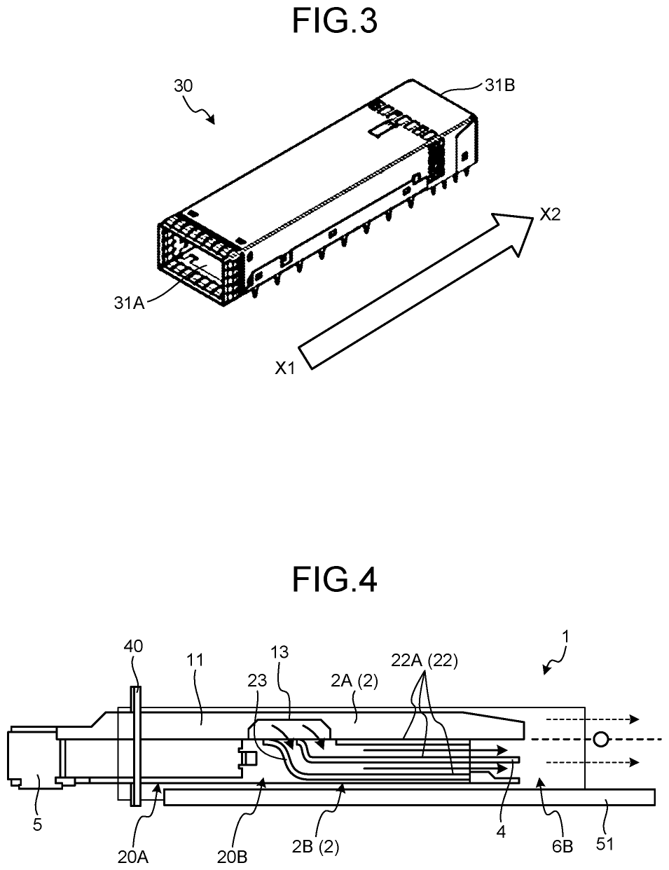

The slide sheet metal 5 is a member that is installed in the first side surface section 20A included in the bottom case 2B, and that is used when the optical module 1 is mounted or taken out from an external case 30 that is contained in the optical transmission apparatus. FIG. 3 is a perspective view illustrating an example of the external case 30.

The external case 30 illustrated in FIG. 3 includes an insertion opening 31A through which the optical module 1 is inserted, a discharge opening 31B that is disposed opposite the insertion opening 31A, and a flow channel (not illustrated) that allows the air from the optical module 1 to flow to the discharge opening 31B. The optical module 1 is inserted from the insertion opening 31A included in the external case 30 to the rear X2 of the optical module 1, so that the optical module 1 is accordingly accommodated in the external case 30.

The case 2 included in the optical module 1 is provided with an Electro Magnetic Interference (EMI) finger that blocks electromagnetic waves. The EMI finger 40 is a member that blocks the electromagnetic waves generated in the interior of the optical module 1 when the optical module 1 is mounted in the external case 30. In addition, for convenience of description, a drawing of the EMI finger 40 is omitted in the exploded perspective view illustrated in FIG. 1.

FIG. 4 is a schematic side view illustrating an example of a flow of the air in the optical module 1 according to the first embodiment. In addition, in the case where the optical module 1 is mounted on the optical transmission apparatus that is not illustrated, the air flows from the front X1 toward the rear X2 of the optical module 1 as a result of the fan included in the optical transmission apparatus being driven, so that the optical module 1 is accordingly cooled. In the optical module 1, the air flows from the front X1 to the rear X2 by way of the first fins 12A that are included in the first heat sink 12 included in the upper case 2A, so that it is possible to radiate heat from the top surface of the case 2 and locally cool the built-in optical component 3 and the built-in electronic component 8.

In addition, in the optical module 1, some of the air flowing from the duct 13 that is formed on the side walls 11 of the upper case 2A to the first fins 12A flows the second fins 22A formed in the third side surface section 20C by way of the side surface flow channel 23 formed in the bottom case 2B. As a result, it is possible to radiate heat from the rear side surfaces of the optical module 1 and locally cool the built-in optical component 3 and the built-in electronic component 8 by the flowing air.

The optical module 1 according to the first embodiment radiates heat from the top surface of the optical module 1 by using the air flowing through the first fins 12A included in the first heat sink 12. In addition, the optical module 1 radiates heat from the rear side surfaces of the optical module 1 by using the air flowing from the first heat sink 12 through the second fins 22A included in the second heat sink 22 by way of the duct 13. As a result, it is possible to radiate heat from top surface and the rear side surfaces of the optical module 1 and locally cool the built-in optical component 3 and the built-in electronic component 8 by using the flowing air.

In the optical module 1, the duct 13 that is used to draw the air from the first fins 12A included in the first heat sink 12 into the second fins 22A included in the second heat sink 22 is formed on the side walls 11 of the upper case 2A. As a result, it is possible to radiate heat of the top surface and the rear side surfaces of the optical module 1 and locally cool the built-in optical component 3 and the built-in electronic component 8 by using the flowing air.

In addition, in the optical module 1 according to the first embodiment, a case has been described as an example in which the first heat sink 12 is provided on the top surface of the case 2; however, the first heat sink 12 does not need to be provided as long as the duct 13 is provided on the side walls 11 of the upper case 2A that is disposed on the top surface of the case 2, and appropriate modifications are possible.

In addition, in the optical module 1 according to the first embodiment, a case has been described as an example of a structure that is configured to include the duct 13 functioning as the flow channel through which the air flows from the first fins 12A to the second fins 22A and that is configured to cool the rear side surface of the bottom case 2B included in the optical module 1 by using the air. However, it may be possible to cool not only the rear side surfaces of the bottom case 2B included in the optical module 1 but also the front side surfaces of the bottom case 2B included in the optical module 1, and an embodiment thereof will be described below as a the second embodiment. In addition, by assigning the same reference numerals to components having the same configuration as those in the optical module 1 according to the first embodiment, overlapped descriptions of the configuration and the operation thereof will be omitted.

### (b) Second Embodiment

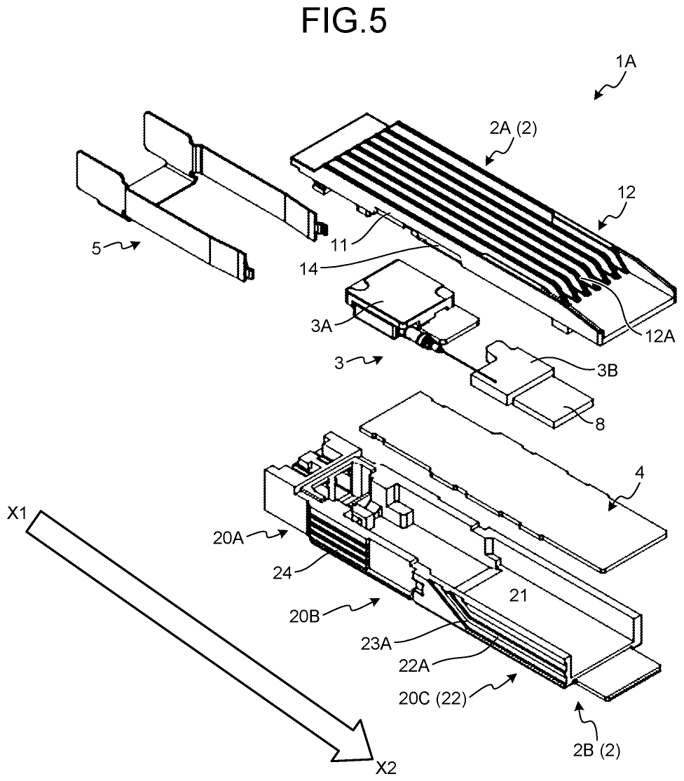

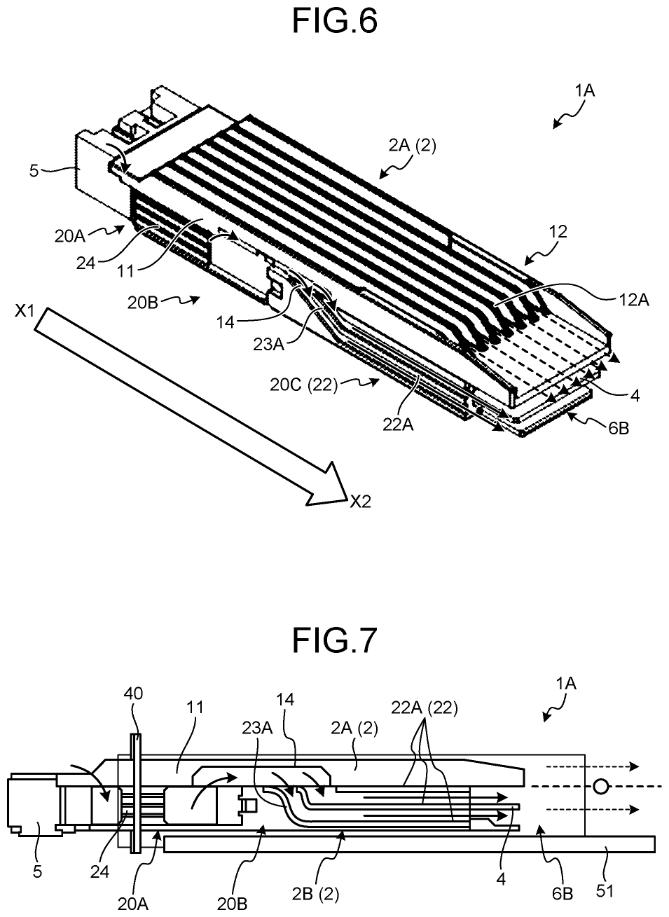

FIG. 5 is an exploded perspective view illustrating an example of an optical module 1A according to the second embodiment, and FIG. 6 is a perspective view illustrating an example of the optical module 1A according to the second embodiment. In the first side surface section 20A included in the bottom case 2B in the optical module 1A illustrated in FIG. 5, a first side surface flow channel 24 through which air flows from the front X1 to the rear X2 is formed. The first side surface flow channel 24 functions as a first ventilation path through which the air flows from the front X1 toward the rear X2 at the back surface of the slide sheet metal 5 as a result of the slide sheet metal 5 being installed in the first side surface section 20A. Furthermore, in the third side surface section 20C included in the bottom case 2B, the second heat sink 22 through which air flows from the front X1 toward the rear X2 is formed. In the second side surface section 20B included in the bottom case 2B, a second side surface flow channel 23A is formed such that the air flows through the second fins 22A when the bottom case 2B is installed together with the upper case 2A. The second side surface flow channel 23A and the second fins 22A correspond to second ventilation paths.

Furthermore, a slit 14 that is a recess section is formed at the center of the side walls 11 of the upper case 2A. The slit 14 correspond to a third ventilation path that draws air from the first side surface flow channel 24 included in the bottom case 2B and that guides the air to the second side surface flow channel 23A included in the bottom case 2B.

The flow channel includes the first side surface flow channel 24 that functions as the first ventilation path, the second side surface flow channel 23A, the second fins 22A, and the slit 14, and the air flows in the longitudinal direction by way of the first side surface flow channel 24, the slit 14, the second side surface flow channel 23A, and the second fins 22A.

FIG. 7 is a schematic side view illustrating an example of the flow of the air in the optical module 1A according to the second embodiment. In addition, in the case where the optical module 1A is mounted on the optical transmission apparatus that is not illustrated, the air flows from the front X1 toward the rear X2 of the optical module 1A as a result of the fan included in the optical transmission apparatus being driven. The first side surface flow channel 24 located in the first side surface section 20A included in the bottom case 2B draws the air from the front X1 and guides the air to the slit 14 that is formed on the side walls 11 of the upper case 2A. Furthermore, the second side surface flow channel 23A included in the bottom case 2B guides the air flowing from the slit 14 to the second fins 22A included in the second heat sink 22. Then, the air flows through the second fins 22A by way of the second side surface flow channel 23A toward the rear X. As a result, the optical module 1 is able to radiate heat from the side surface section as a result of the air flowing to the rear by way of the first side surface flow channel 24, the slit 14, the second side surface flow channel 23A, and the second fins 22A. Then, it is possible to locally cool the optical component 3 and the electronic component 8 that are included in the optical module 1A.

The optical module 1A according to the second embodiment includes the first side surface flow channel 24 that is formed in the first side surface section 20A, and the second side surface flow channel 23A that is formed in the third side surface section 20C and that draws the air from the first side surface flow channel 24 into the second fins 22A. Furthermore, the optical module 1A includes the slit 14 that is formed in the second side surface section 20B, and furthermore, the air flows through the second fins 22A by way of the first side surface flow channel 24, the slit 14, and the second side surface flow channel 23A. As a result, it is possible to radiate heat from the side surface section portion of the optical module 1A and locally cool the optical component 3 and the electronic component 8.

In addition, in the optical module 1A according to the second embodiment, a case has been described as an example in which the first heat sink 12 is provided on the top surface of the case 2; however, the first heat sink 12 does not need to be provided, and appropriate modifications are possible.

In addition, in the optical module 1A according to the second embodiment, a case has been described as an example in which the front side surface of the bottom case 2B is cooled, in addition to the rear side surface of the bottom case 2B. However, it may be possible to draw air into an optical module 1B, and an embodiment thereof will be described below as a third embodiment. In addition, by assigning the same reference numerals to components having the same configuration as those in the optical module 1 according to the first embodiment, overlapped descriptions of the configuration and the operation thereof will be omitted.

### (c) Third Embodiment

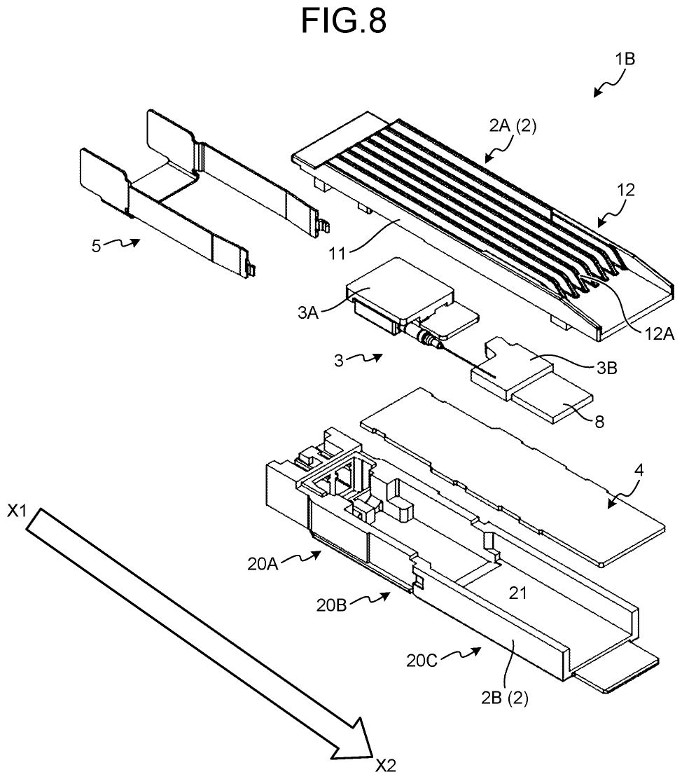

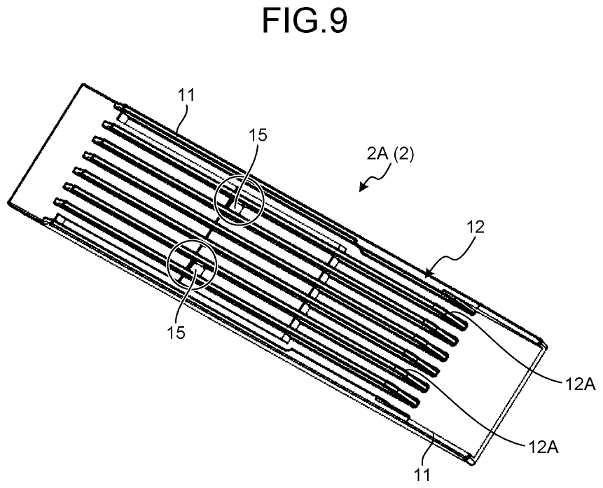

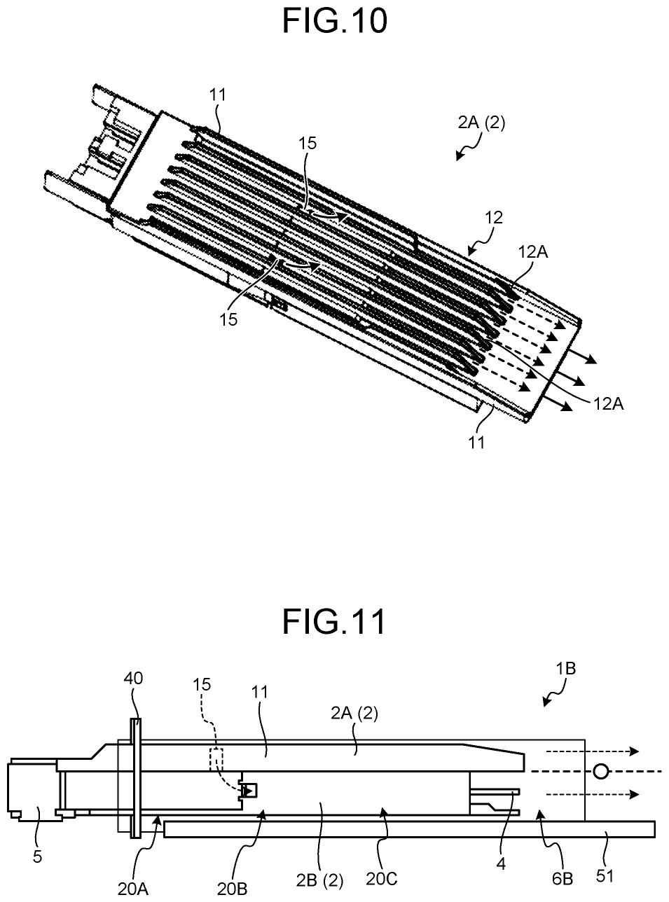

FIG. 8 is an exploded perspective view illustrating an example of the optical module 1B according to the third embodiment, FIG. 9 is a perspective view illustrating an example of the upper case 2A, and FIG. 10 is a perspective view illustrating an example of the optical module 1B according to the third embodiment. The side walls 11 of the upper case 2A included in the optical module 1B illustrated in FIG. 8 does not include the duct 13 as described above in the first embodiment, and has a flat surface. The third side surface section 20C included in the bottom case 2B in the optical module 1B does not include the second heat sink 22 as described above in the first embodiment, and has a flat surface.

In the first heat sink 12, air flows from a first duct 15 to the rear of the optical module 1B as a result of forming the first duct 15 that functions as the first ventilation hole that passes through the front and back sides of the top surface of the upper case 2A. The flow channel is formed in the case 2, and includes the first duct 15 that passes through the front and back sides of the case top surface, so that air accordingly flows through a portion between the upper case 2A included in the case 2 and the bottom case 2B included in the case 2 by way of the first duct 15.

FIG. 11 is a schematic side view illustrating an example of the flow of air in the optical module 1B according to the third embodiment. In addition, in the case where the optical module 1B is mounted on the optical transmission apparatus that is not illustrated, the air flows from the front X1 toward the rear X2 of the optical module 1B as a result of the fan included in the optical transmission apparatus being driven. The optical module 1B radiates heat from the top surface of the optical module 1B by using the air flowing through the first fins 12A included in the first heat sink 12. Furthermore, the air flows from the first duct 15 that passes through the front and back sides of the top surface of the upper case 2A toward the rear of the case 2, so that the optical module 1B accordingly radiates heat from the interior of the optical module 1B. As a result, it is possible to locally cool the optical component 3 and the electronic component 8 included in the optical module 1B.

In addition, in the optical module 1B according to the third embodiment, a case has been described as an example in which the first heat sink 12 is provided on the top surface of the case 2; however, the first heat sink 12 does not need to be provided as long as the first duct 15 is provided on the top surface of the case 2, and appropriate modifications are possible.

In addition, in the optical module 1B according to the third embodiment, a case has been described as an example in which the first duct 15 that passes through the front and back sides of the top surface of the upper case 2A; however, the second heat sink 22 may be disposed in the side surface section included in the bottom case 2B. In addition, the first duct 15 may be disposed in the optical module 1 according to the first embodiment. Furthermore, the first duct 15 may be disposed in the optical module 1A according to the second embodiment, and appropriate modifications are possible.

In addition, in the optical module 1B according to the third embodiment, a heat radiation structure is not provided on the side surface of the bottom case 2B; however, the heat radiation structure may be provided on the side surfaces of the bottom case 2B, and an embodiment thereof will be described below as a fourth embodiment. In addition, by assigning the same reference numerals to components having the same configuration as those in the optical module 1B according to the third embodiment, overlapped descriptions of the configuration and the operation thereof will be omitted.

### (d) Fourth Embodiment

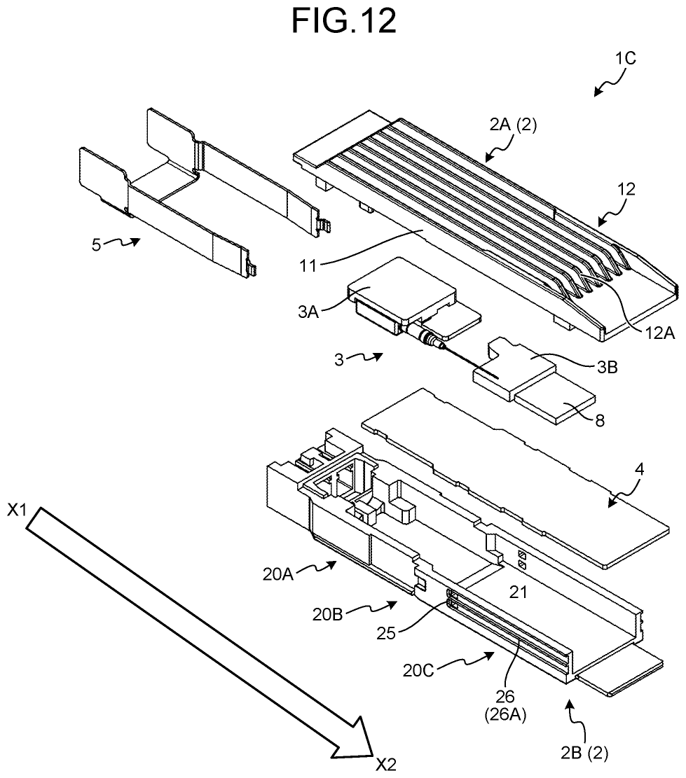

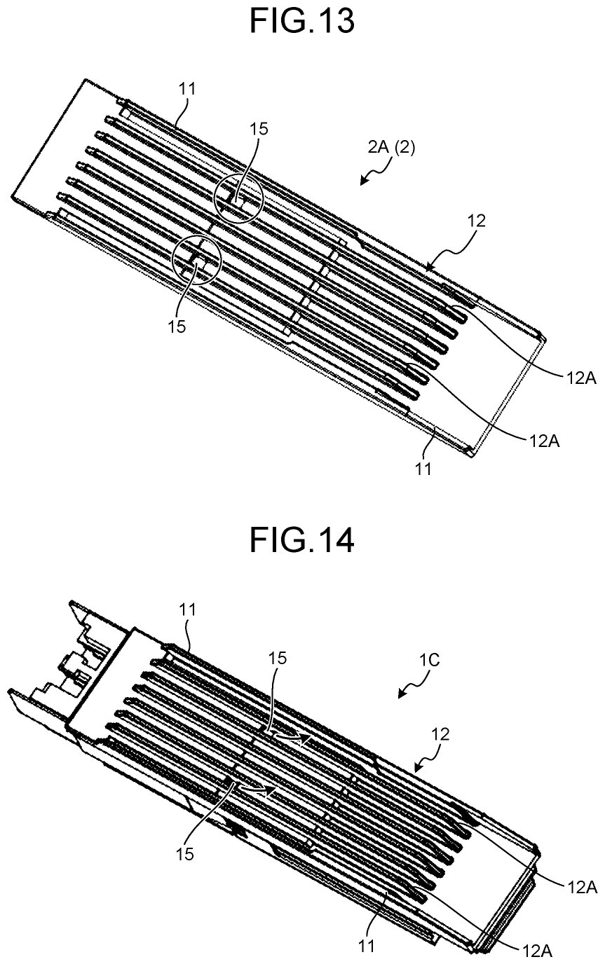

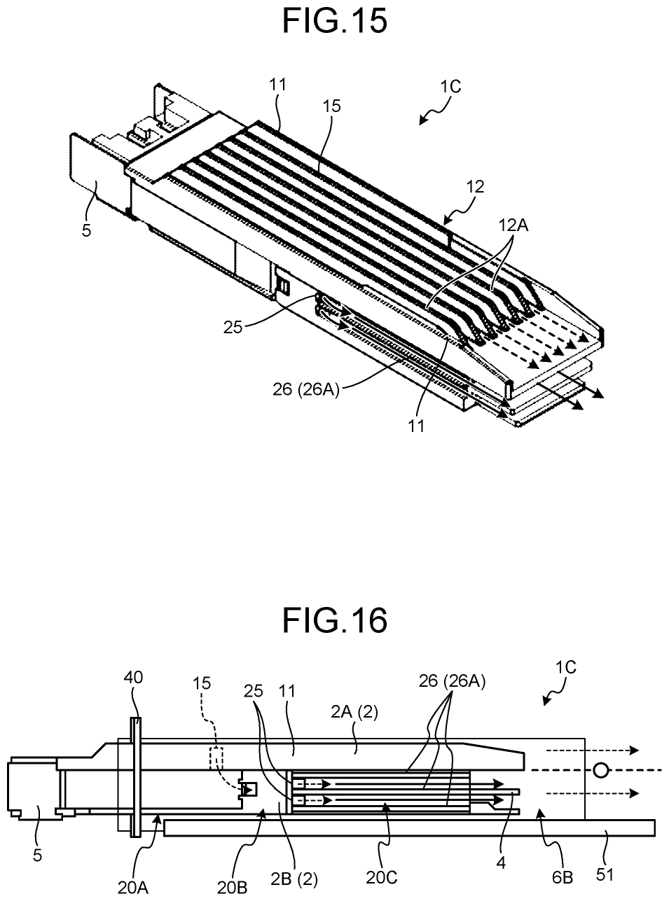

FIG. 12 is an exploded perspective view illustrating an example of an optical module 1C according to the fourth embodiment, FIG. 13 is a perspective view illustrating an example of the upper case 2A, FIG. 14 is a perspective view illustrating an example of the optical module 1C according to the fourth embodiment, and FIG. 15 is a perspective view illustrating an example of the optical module according to the fourth embodiment. The optical module 1C according to the fourth embodiment is different from the optical module 1B according to the third embodiment in that a third heat sink 26 is formed in the third side surface section 20C included in the bottom case 2B.

In the region located at the portion between the first fins 12A included in the first heat sink 12 disposed on the front surface of the upper case 2A, the first duct 15 that passes through the front and back sides of the top surface of the upper case 2A is formed, so that air flows from the first duct 15 toward the rear of the optical module 1C. The first duct 15 corresponds to the first ventilation hole.

In the third side surface section 20C included in the bottom case 2B, the third heat sink 26 that radiates heat from the side surface section located at the rear portion of the optical module 1C is formed. The third heat sink 26 includes a plurality of third fins 26A through which air flows from the front X1 toward the rear X2 of the optical module 1C, and radiates heat from the rear side surface of the optical module 1C as a result of the air flowing from the front X1 toward the rear X2 by way of the third fins 26A. The third fins 26A correspond to the ventilation path.

A second duct 25 passing through the front and back sides of the bottom case 2B is formed in the second side surface section 20B included in the bottom case 2B, and the air flowing from the second duct 25 through the third fins 26A included in the third heat sink 26, so that heat is radiated from the side surface of the optical module 1C. The second duct 25 corresponds to the second ventilation hole.

FIG. 16 is a schematic side view illustrating an example of the flow of the air in the optical module 1C according to the fourth embodiment. In addition, in the case where the optical module 1C is mounted on the optical transmission apparatus that is not illustrated, air flows from the front X1 toward the rear X2 of the optical module 1C as a result of driving the fan included in the optical transmission apparatus. The optical module 1C radiates heat from the top surface of the optical module 1C by using the air flowing through the first fins 12A included in the first heat sink 12. As a result, it is possible to locally cool the optical component 3 and the electronic component 8 included in the optical module 1B.

Furthermore, the optical module 1C includes the first duct 15 that passes through the front and back sides of the portion between the first fins 12A, and radiates heat from the interior of the optical module 1C as a result of the air flowing from the first fins 12A to a discharge opening 6B included in the accommodating section 21 by way of the first duct 15. As a result, it is possible to locally cool the optical component 3 and the electronic component 8 included in the optical module 1B.

Furthermore, the optical module 1C includes the second duct 25 that passes through the front and back sides of the second side surface section 20B included in the bottom case 2B, and the third fins 26A that is included in the third heat sink 26 and that is disposed in the third side surface section 20C in the bottom case 2B. The optical module 1C radiates heat from the side surface section portion of the optical module 1C as a result of the air flowing through the third fins 26A by way of the second duct 25. As a result, it is possible to locally cool the optical component 3 and the electronic component 8 included in the optical module 1B.

In addition, it is assumed that the width of the opening in the case where the first duct 15 illustrated in FIGS. 9 and 13 is located in front of the EMI finger 40 is defined as X (mm)=3.0×10¹¹/(F×2) or below, where an internal frequency is denoted by F (Hz). In addition, in the case where the internal frequency is 100 GHz, it is assumed that, for example, the width of the opening in the case where the insertion opening of the first duct 15 is located in front of the EMI finger 40 is defined as 3.0×10¹¹/(100×2×10⁹)=1.5 mm or below.

### (e) Fifth Embodiment

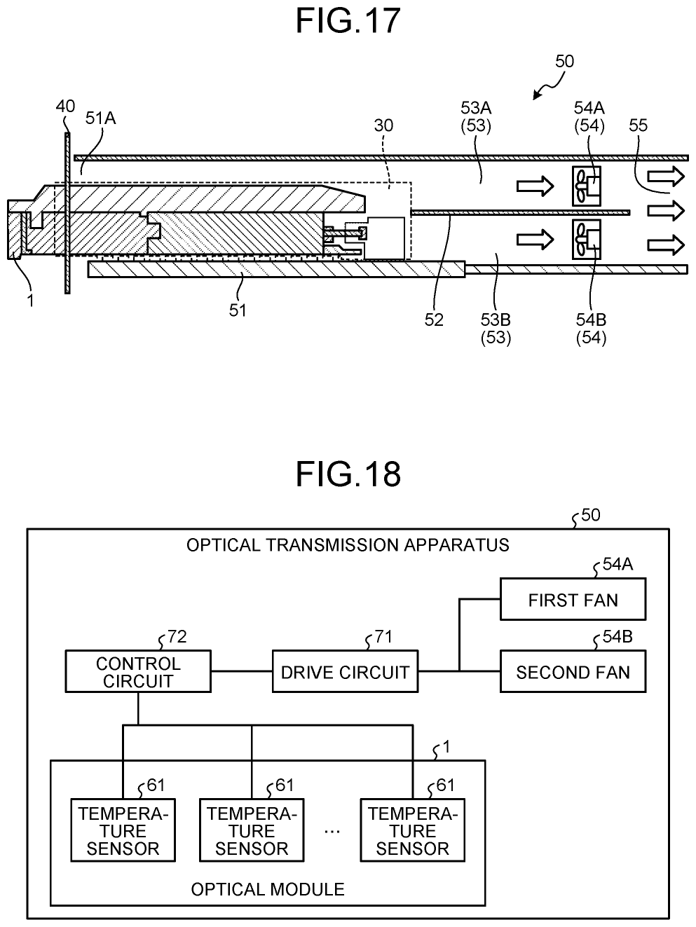

In the following, an optical transmission apparatus 50 having mounted thereon the optical module 1 according to the first to the fourth embodiments will be described. FIG. 17 is a schematic cross-sectional diagram illustrating an example of the optical transmission apparatus 50 according to a fifth embodiment. The optical transmission apparatus 50 illustrated in FIG. 17 accommodates the external case 30 that accommodates the optical module 1. The optical transmission apparatus 50 includes a mounting section 51, an insertion opening 51A, a separator 52, a flow channel 53, a fan 54, and a discharge opening 55. The mounting section 51 is a region on which the external case is mounted. The insertion opening 51A is an opening section for inserting the external case 30 on which the optical module 1 is mounted. The flow channel 53 is a flow channel that allows the air from the rear of the optical module 1 to flow to the discharge opening 55. The separator 52 divides the flow channel 53 into the upper and lower parts. Accordingly, the flow channel 53 includes, by using the separator 52, a first flow channel 53A and a second flow channel 53B. The fan 54 is a fan for discharging the air inside the flow channel 53 to the discharge opening 55. The fan 54 includes a first fan 54A that supports the flow of the air flowing through the first flow channel 53A, and a second fan 54B that supports the flow of the air flowing through the second flow channel 53B. The discharge opening 55 is an opening portion that discharges heat to the rear of the optical module 1 and that is disposed opposite the insertion opening 51A.

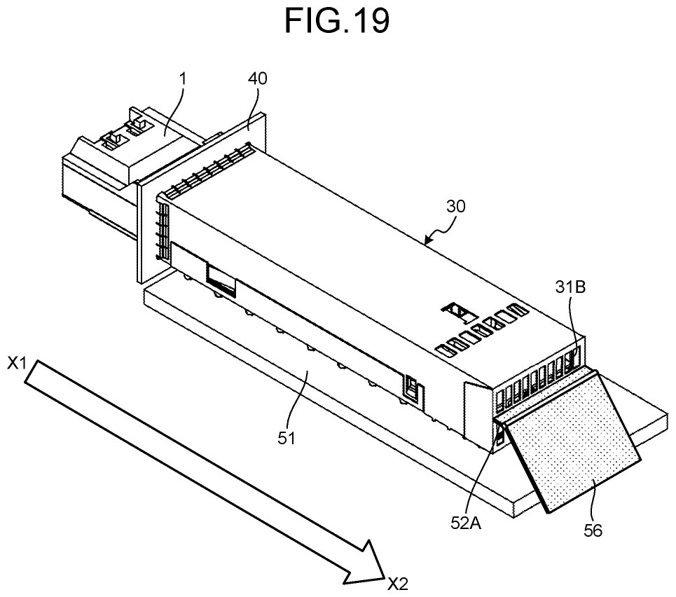

FIG. 18 is a block diagram illustrating an example of a configuration of the optical transmission apparatus 50 according to the fifth embodiment. The optical transmission apparatus 50 illustrated in FIG. 18 includes the optical module 1, the first fan 54A, the second fan 54B, a drive circuit 71, and a control circuit 72. The optical module 1 includes temperature sensors 61 that detect, for each of the optical components 3 and the electronic component 8 included in the case 2, the temperature of the components, such as the optical components 3 and the electronic component 8, and that detect the temperature of each of the regions included in the case 2. Each of the temperature sensors 61 is a sensor conforming to a structure (Common Management Interface Specification, CMIS 5.0) capable of monitoring the temperature of the optical components 3.

The drive circuit 71 performs drive control of the first fan 54A as well as performs drive control of the second fan 54B. The control circuit 72 identifies the temperature of each of the optical components 3 and each of the regions included in the optical module 1 on the basis of the detection result obtained by the temperature sensor 61 provided in association with each of the optical components 3, and performs control of an amount of rotation of the first fan 54A and the second fan 54B. In addition, the optical module 1 is one of the optical modules described in the first to the fourth embodiments.

The control circuit 72 performs control of an amount of rotation of the first fan 54A on the basis of the temperature of the first fin 12A side. If the temperature of, for example, the first fin 12A side exceeds a reference temperature, the control circuit 72 decreases the temperature of the first fins 12A by increasing the flow rate of the air flowing through the first flow channel 53A by increasing an amount of rotation of the first fan 54A. As a result, it is possible to locally cool the optical components 3 and the electronic component 8 by radiating heat from the top surface side of the optical module 1 included in the optical transmission apparatus 50.

The control circuit 72 performs control of an amount of rotation of the second fan 54B on the basis of the temperature of the second fin 22A side. If the temperature of, for example, the second fin 22A side exceeds the reference temperature, the control circuit 72 decreases the temperature of the second fins 22A by increasing the flow rate of the air flowing through the second flow channel 53B by increasing an amount of rotation of the second fan 54B. As a result, it is possible to locally cool the optical components 3 and the electronic component 8 by radiating heat from the side surface side of the optical module 1 included in the optical transmission apparatus 50.

In the optical transmission apparatus 50 according to the fifth embodiment, by performing drive control of the fan 54 by dividing the flow channel 53 into the upper and lower parts by using the separator 52, the flow rate of the air inside the first flow channel 53A that is located on an upper stage of the optical module 1 or the flow rate of the air inside the second flow channel 53B that is located on a lower stage of the optical module 1 is adjusted. As a result, it is possible to locally cool the optical components 3 and the electronic component 8 by radiating heat from the optical module 1 included in the optical transmission apparatus 50.

In addition, in the optical transmission apparatus 50 according to the fifth embodiment, a case has been described as an example in which the first flow channel 53A and the second flow channel 53B are formed from the flow channel 53 by using the separator 52. However, a flap 56 that is driven in the vertical direction of the flow channel 53 may be provided at a front end of the separator 52, and an embodiment thereof will be described below as a sixth embodiment. In addition, by assigning the same reference numerals to components having the same configuration as those in the optical transmission apparatus 50 according to the fifth embodiment, overlapped descriptions of the configuration and the operation thereof will be omitted.

### (f) Sixth Embodiment

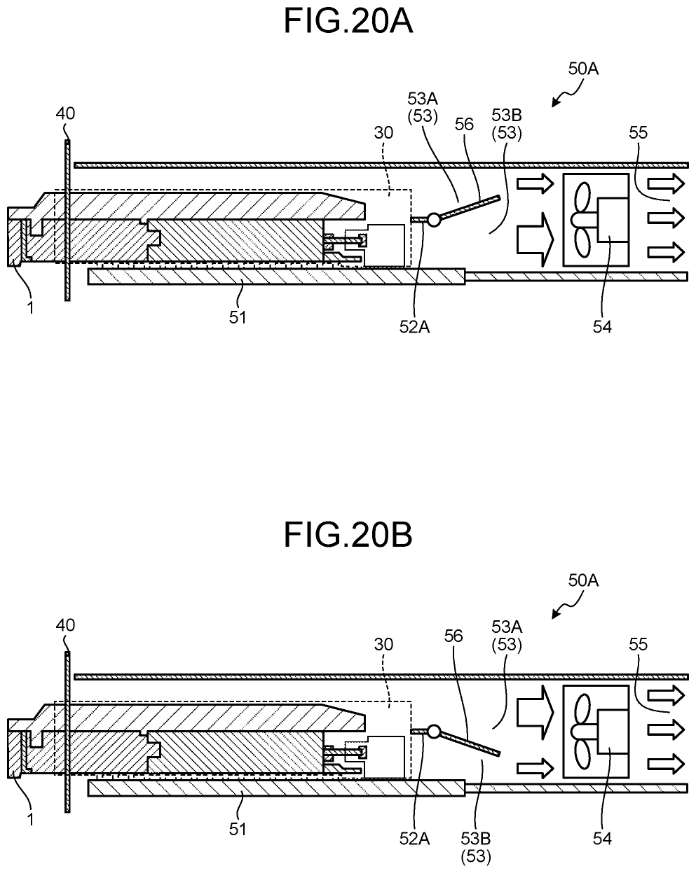

FIG. 19 is a perspective view illustrating an example of an optical transmission apparatus 50A according to the sixth embodiment, and FIG. 20A and FIG. 20B are schematic cross-sectional diagrams each illustrating the optical transmission apparatus according to the sixth embodiment. The optical transmission apparatus 50A according to the sixth embodiment is different from the optical transmission apparatus 50 according to the fifth embodiment in that the flap 56 that is driven in the vertical direction is provided at the front end of a separator 52A in order to divide the flow channel 53 into the vertical direction.

The optical transmission apparatus 50A allows the flap 56 to be driven in the vertical direction and divides the flow channel 53 into the upper and lower parts, so that the optical transmission apparatus 50A forms the first flow channel 53A and the second flow channel 53B. The optical transmission apparatus 50A increases the region of the second flow channel 53B as a result of driving the flap 56 in the upward direction, and increases the region of the first flow channel 53A as a result of driving the flap 56 in the downward direction. The optical transmission apparatus 50 is disposed inside the flow channel 53, and includes the fan 54 that allows the air flowing through the first flow channel 53A and the second flow channel 53B formed by the flap 56 to flow to the discharge opening.

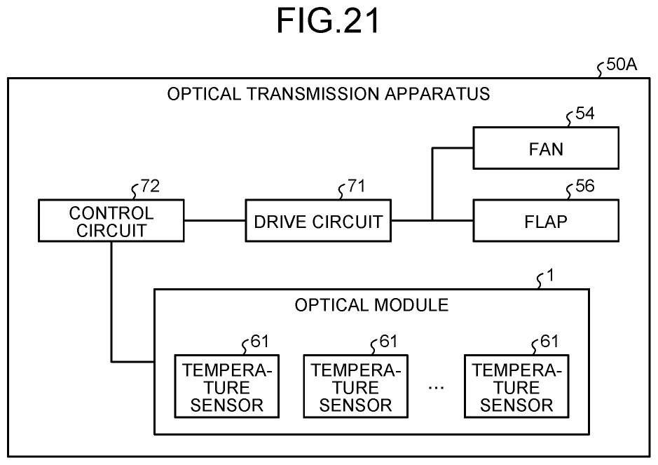

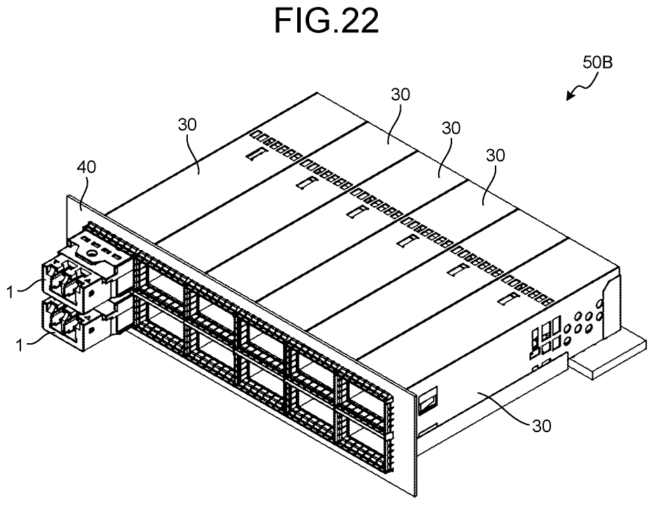

FIG. 21 is a block diagram illustrating an example of a configuration of the optical transmission apparatus 50A according to the sixth embodiment. The optical transmission apparatus 50A illustrated in FIG. 21 includes the optical module 1, the fan 54, the flap 56, the drive circuit 71, and the control circuit 72. The drive circuit 71 performs drive control of an amount of rotation of the fan 54 and a position of the flap 56. The control circuit 72 performs control of the drive circuit 71 on the basis of the sensor result obtained by the temperature sensor 61 provided in association with each of the optical components 3 included in the optical module 1.

The control circuit 72 performs control of the drive circuit 71 that performs drive control of the fan 54 and the flap 56 on the basis of the temperature of the first fin 12A side and the temperature of the second fin 22A side. If the temperature of, for example, the first fin 12A side exceeds a reference temperature, as illustrated in FIG. 20B, the control circuit 72 decreases the temperature of the first fin 12A by increasing the flow rate of the air flowing through the first flow channel 53A by increasing the first flow channel 53A as a result of driving the flap 56 in the downward direction. As a result, it is possible to locally cool the optical component 3 and the electronic component 8 by radiating heat from the top surface side of the optical module 1 included in the optical transmission apparatus 50A.

If the temperature of, for example, the second fin 22A side exceeds the reference temperature, as illustrated in FIG. 20A, the control circuit 72 decreases the temperature of the second fin 22A by increasing the flow rate of the air flowing through the second flow channel 53B by increasing the region of the second flow channel 53B as a result of driving the flap 56 in the upward direction. As a result, it is possible to locally the optical components 3 and the electronic component 8 by radiating heat from the side surface side of the optical module 1 included in the optical transmission apparatus 50A.

In the optical transmission apparatus 50A according to the sixth embodiment, the flow rate of the air inside the first flow channel 53A that is the upper stage side of the optical module 1 or the flow rate of the air inside the second flow channel 53B that is the lower stage side of the optical module 1 is adjusted by performing drive control of the flap 56 that divides the flow channel 53 into the upper and lower parts and the fan 54. As a result, it is possible to locally cool the optical components 3 and the electronic component 8 by radiating heat from the optical module 1 included in the optical transmission apparatus 50A.

In addition, for convenience of description, the optical transmission apparatus 50 according to the fifth embodiment having mounted thereon the single optical module 1 has been described as an example; however, the plurality of optical modules 1 may be mounted in parallel, and an embodiment thereof will be described as a seventh embodiment. In addition, by assigning the same reference numerals to components having the same configuration as those in the optical transmission apparatus 50 according to the fifth embodiment, overlapped descriptions of the configuration and the operation thereof will be omitted.

### (g) Seventh Embodiment

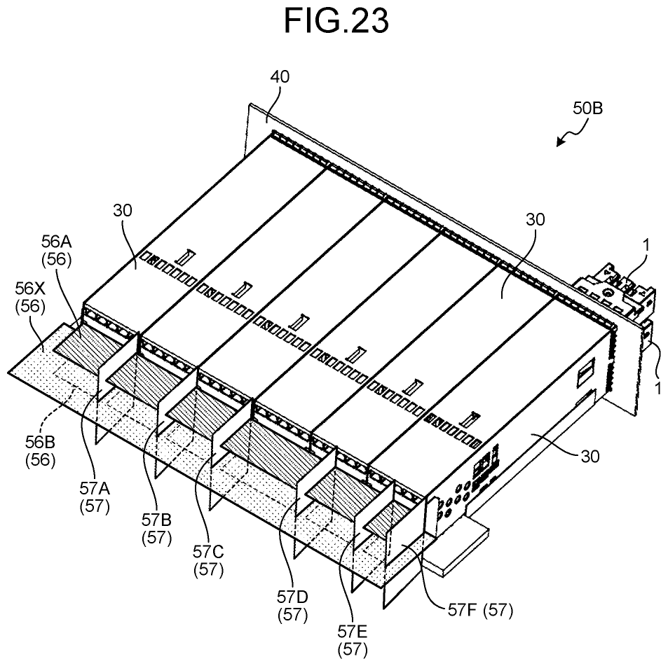

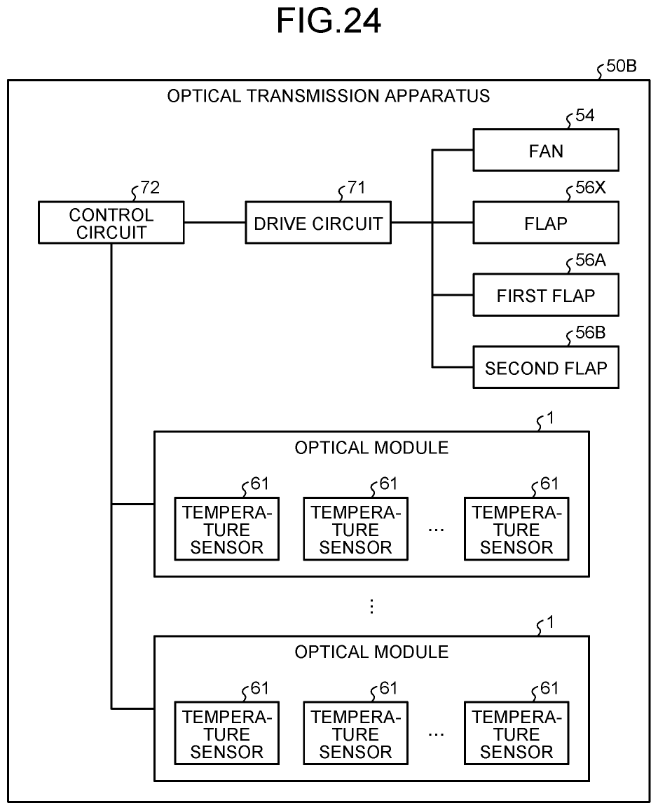

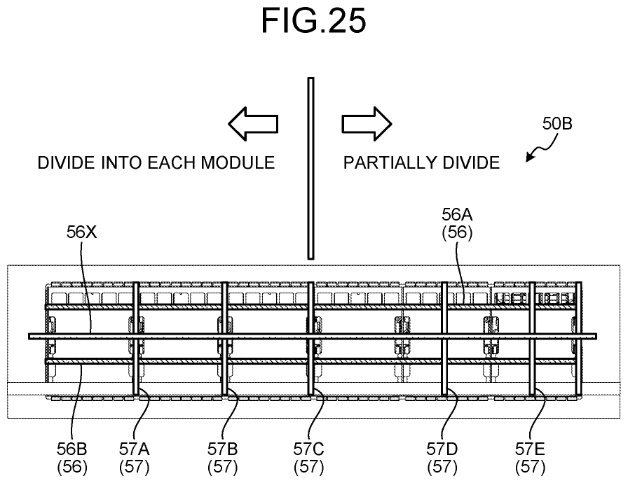

FIG. 22 is a schematic perspective view illustrating an example of the front face side of an optical transmission apparatus 50B according to the seventh embodiment, FIG. 23 is a schematic perspective view illustrating an example of the back face side of the optical transmission apparatus 50B according to the seventh embodiment, FIG. 24 is a block diagram illustrating an example of a configuration of the optical transmission apparatus according to the seventh embodiment, and FIG. 25 is a rear view illustrating an example of the optical transmission apparatus according to the seventh embodiment. The optical transmission apparatus 50B illustrated in FIG. 22 has a structure in which the six optical modules 1 are mounted in parallel in each of the stages that are disposed in two stages, i.e., an upper stage and a lower stage. The optical transmission apparatus 50B illustrated in FIG. 23 includes a flap 56X (56) that is driven in the vertical direction and that divides the flow channel 53 into the upper and lower parts in order to form the first flow channel 53A and the second flow channel 53B, and six vertical separators 57 each of which divides the flow channel 53 into the right and left sides. Furthermore, the optical transmission apparatus 50B includes a first flap 56A (56) that is driven in the vertical direction in order to divide the first flow channels 53A divided by the flap 56X into the vertical direction. The optical transmission apparatus 50B includes a second flap 56B (56) that is driven in the vertical direction in order to divide the second flow channels 53B divided by the flap 56X into the vertical direction, and the fan 54 that is disposed in each of the optical modules 1. Each of the fans 54 flows the air from the rear of the optical module 1 to the discharge opening 55 disposed in each of the optical modules 1.

Vertical separators 57A to 57C divide, for example, the flow channel 53 into each of the optical modules 1 that are disposed in two stages, i.e., an upper stage and a lower stage. Vertical separators 57D to 57F are not limited to each of the optical modules 1 disposed in two stages, i.e., an upper stage and a lower stage, and divide the flow channel 53 within a predetermined range.

The optical transmission apparatus 50B divides the flow channel 53 disposed in each of the optical modules 1 by using the vertical separator 57, and in which the fan 54 is disposed in each of the divided flow channels 53.

The control circuit 72 performs drive control of the fan 54 that allows the air in the flow channels 53 associated with the respective optical modules 1 to flow on the basis of the monitoring results obtained by the respective temperature sensors 61 included in the respective optical modules 1. If the monitoring result of the target optical module 1 exceeds the reference temperature from among, for example, the twelve optical modules 1, the control circuit 72 increases an amount of fan rotation of the fan 54, which is disposed in the flow channel 53 associated with the optical module 1 whose temperature exceeds the reference temperature, such that the amount of fan rotation of the fan 54 is larger than the amount of fan rotation of the other fans 54. Then, the control circuit 72 is able to partially adjust the flow rate of the air by increasing the flow rate of the air in the target optical module 1. As a result, it is possible to locally cool the optical components 3 and the electronic component 8 by radiating heat from each of the optical module 1 included in the optical transmission apparatus 50B.

The control circuit 72 performs drive control of the flap 56X, the first flap 56A, and the second flap 56B disposed in the flow channel 53 associated with each of the optical modules 1 on the basis of the monitoring result obtained from the temperature sensors 61 included in the associated optical modules 1. The control circuit 72 is able to adjust the flow rate of the air in the optical module 1 whose temperature exceeds the reference temperature by adjusting the flap 56X, the first flap 56A, and the second flap 56B that are associated with the target optical module 1. As a result, it is possible to locally the optical components 3 and the electronic component 8 by radiating heat from each of the optical modules 1 included in the optical transmission apparatus 50B.

In addition, in the optical transmission apparatus 50B according to the seventh embodiment, a case has been described in which the flaps 56X, the first flaps 56A, and the second flaps 56B that are driven in the vertical direction are disposed. However, it may possible to use a first horizontal separator instead of the first flap 56A, a second horizontal separator instead of the second flap 56B, and a separator instead of the flap 56X, and appropriate modifications are possible. As a result, it is possible to vertically and horizontally divide the flow channel 53 included in the optical transmission apparatus 50B.

In addition, for convenience of description, in the optical transmission apparatus 50 according to the fifth embodiment, a case has been described as an example in which the single optical module 1 is mounted; however, the plurality of optical modules 1 may be mounted in parallel, and an embodiment thereof will be described below as an eighth embodiment. In addition, by assigning the same reference numerals to components having the same configuration as those in the optical transmission apparatus 50 according to the fifth embodiment, overlapped descriptions of the configuration and the operation thereof will be omitted.

### (h) Eighth Embodiment

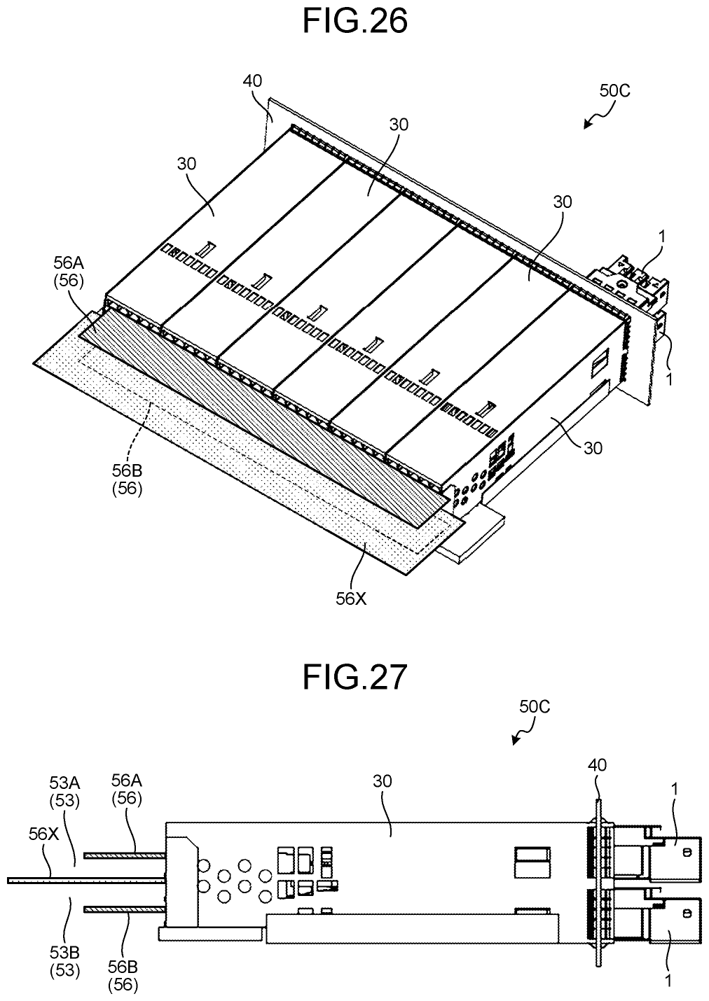

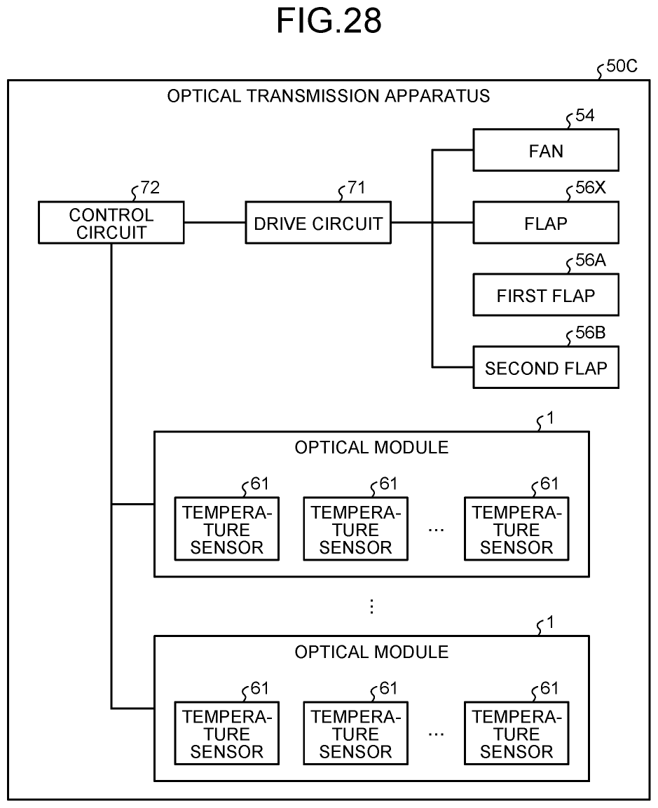

FIG. 26 is a schematic perspective view illustrating an example of the back face side of an optical transmission apparatus according to the eighth embodiment, FIG. 27 is a schematic side view illustrating an example of the optical transmission apparatus according to the eighth embodiment, and FIG. 28 is a block diagram illustrating an example of a configuration of the optical transmission apparatus according to the eighth embodiment. The optical transmission apparatus illustrated in FIG. 26 has a structure in which, for example, the six optical modules 1 are mounted in parallel in each of the stages, and two stages, i.e., an upper stage and a lower stage, are used. An optical transmission apparatus 50C includes the flaps 56X (56) that are driven in the vertical direction in order to form the first flow channel 53A and the second flow channel 53B by dividing the flow channel 53 into the upper and lower parts. The optical transmission apparatus 50C includes the first flap 56A (56) that is driven in the upper and lower parts of the first flow channel 53A, and the second flap 56B (56) that is driven in the upper and lower parts of the second flow channel 53B.

In the optical transmission apparatus 50C, the flow channel 53 is divided into the first flow channel 53A and the second flow channel 53B included in the optical module 1 group by using the flap 56X, and the fan 54 is disposed in each of the divided flow channels 53. The fan 54 allows the air to flow from the rear of the optical module 1 to the discharge opening that is disposed in each of the optical modules 1.

The control circuit 72 performs drive control of the fan 54 disposed in each of the optical modules 1 on the basis of the monitoring result obtained by the temperature sensors 61 included in each of the optical modules 1. If the monitoring result obtained by the target optical module 1 exceeds the reference temperature from among, for example, the twelve optical modules 1, the control circuit 72 increases an amount of fan rotation of the fan 54 disposed in the flow channel 53 associated with the optical module 1 whose temperature exceeds the target reference temperature such that the amount of fan rotation of the fan 54 is larger than the amount of fan rotation of the other fans 54. In addition, the control circuit 72 is able to partially adjust the flow rate of the air by increasing the flow rate of the air in the target optical module 1. As a result, it is possible to locally cool the optical components 3 and the electronic component 8 by radiating heat from each of the optical modules 1 included in the optical transmission apparatus 50C.

The control circuit 72 performs drive control of the flap 56X, the first flap 56A, and the second flap 56B included in the flow channel 53 associated with each of the optical modules 1 on the basis of the monitoring result obtained by the temperature sensors 61 included in the respective optical modules 1. The control circuit 72 is able to adjust the flow rate of the air in the optical module 1 whose temperature exceeds the reference temperature by adjusting the first flap 56A and the second flap 56B. As a result, it is possible to locally cool the optical components 3 and the electronic component 8 by radiating heat from each of the optical modules 1 included in the optical transmission apparatus 50C.

According to an aspect of an embodiment of the optical module and the like, it is possible to locally cool a built-in optical component and a built-in electronic component.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical module comprising:
a case that contains a built-in optical component related to optical communication, a built-in electronic component, and a built-in temperature sensor that detects temperature of at least one of the optical component and the electronic component; and
a flow channel that is formed on at least one of surfaces of the case, that extends in a longitudinal direction of the case, and through which air flows.

2. The optical module according to claim 1, wherein the flow channel
includes
a ventilation hole that is provided on a side surface of a first heat sink that is disposed on a top surface of the case, and
a ventilation path that is formed on a side surface of the case, and
allows air inside the first heat sink to flow from the ventilation hole to the ventilation path.

3. The optical module according to claim 1, wherein
the flow channel includes
a first ventilation path that is formed on a side surface of the case, on which a slide sheet metal is installed, and through which air flows in the longitudinal direction,
a second ventilation path that is formed on the side surface of the case and that draws the air from the first ventilation path, and
a third ventilation path that is formed on a side surface of an upper case, and
the air flows in the longitudinal direction by way of the first ventilation path, the third ventilation path, and the second ventilation path.

4. The optical module according to claim 1, wherein
the flow channel includes a first ventilation hole that is formed in the case and that passes through front and back sides of a top surface of the case, and
air flows between an upper case included in the case and a bottom case included in the case via the first ventilation hole.

5. The optical module according to claim 4, wherein
the flow channel includes
a ventilation path that is formed on a side surface of the case, and
a second ventilation hole that is formed in the case and that communicates with the first ventilation hole, and
air flows from the first ventilation hole to the ventilation path by way of the second ventilation hole.

6. An optical transmission apparatus comprising:
an external case that accommodates an optical module;
an insertion opening that is formed in the external case and through which the optical module is inserted;
a discharge opening that is formed in the external case and that is disposed opposite the insertion opening;
a flow channel that is provided inside the external case and through which air from the accommodated optical module flows to the discharge opening;
a separator that divides the flow channel into upper and lower parts;
a fan that generates a flow of air in order to discharge the air inside the flow channel to the discharge opening; and
a control circuit that performs control of the fan, wherein
the optical module includes
a case that contains a built-in optical component related to optical communication, a built-in electronic component, and a built-in temperature sensor that detects temperature of at least one of the optical component and the electronic component, and
a flow channel that is formed on at least one of surfaces of the case, that extends in a longitudinal direction of the case, and that allows air flowing outside the optical module to flow, and
the control circuit performs drive control of the fan based on a detection result obtained by the temperature sensor that is disposed in each of the optical components.

7. The optical transmission apparatus according to claim 6, further including:
a separator that is provided inside the external case and that forms a first flow channel and a second flow channel by dividing the flow channel into upper and lower parts;
a first fan that is disposed in the first flow channel and that generates a flow of air in order to flow the air from the first flow channel to the discharge opening; and
a second fan that is disposed in the second flow channel and that generates a flow of air in order to flow the air from the second flow channel to the discharge opening, wherein
the control circuit performs drive control of the first fan and the second fan based on the detection result obtained by the temperature sensor that is disposed in each of the optical components.

8. The optical transmission apparatus according to claim 6, further including:
a flap that is provided inside the external case and that divides the flow channel into upper and lower parts as a result of moving in the flow channel and forming a first flow channel and a second flow channel; and
the fan that is disposed inside the flow channel and that generates a flow of air in order to flow the air flowing through the first flow channel and the second flow channel that are formed by the flap to the discharge opening, wherein
the control circuit performs drive control of the flap and the fan based on the detection result of the temperature sensor that is disposed in each of the optical components.

9. The optical transmission apparatus according to claim 6, further including:
a separator that is provided inside the external case, on which the plurality of optical modules are mounted in parallel, and that divides the flow channel into right and left parts;
a flap that is provided inside the external case, on which the plurality of optical modules are mounted in parallel, and that divides the flow channel into upper and lower parts; and
the fan that is disposed inside the flow channel and that generates a flow of air in order to flow the air flowing through the first flow channel and the second flow channel that are formed by the flap to the discharge opening, wherein
the control circuit performs drive control of the flap and the fan based on the detection result obtained by the temperature sensor that is disposed in each of the optical components.

10. The optical transmission apparatus according to claim 6, further including:
a flap that is provided inside the external case, on which the plurality of optical modules are mounted in parallel, and that divides the flow channel into upper and lower parts; and
the fan that is disposed inside the flow channel and that generates a flow of air in order to flow the air flowing through the first flow channel and the second flow channel that are formed by the flap to the discharge opening, wherein
the control circuit performs drive control of the flap and the fan based on the detection result obtained by the temperature sensor that is disposed in each of the optical components.
